(19) United States
(12) Patent Application Publication
(10) Pub. No.: US 2011/0069671 A1
(43) Pub. Date: Mar. 24, 2011

(54) WIRELESS COMMUNICATION MOBILE STATION DEVICE AND DISTRIBUTION AND PLACEMENT METHOD FOR RESOURCE ELEMENTS

(75) Inventors: Seigo Nakao, Kanagawa (JP); Hidetoshi Suzuki, Kanagawa (JP); Akihiko Nishio, Kanagawa (JP); Kenichi Kuri, Kanagawa (JP)

(73) Assignee: Panasonic Corporation, Osaka (JP)

(21) Appl. No.: 12/993,404

(22) PCT Filed: May 22, 2009
(86) PCT No.: PCT/JP2009/002268

§ 371 Date: Nov. 18, 2010

(30) Foreign Application Priority Data
May 23, 2008 (JP) 2008-135568

(51) Int. Cl. H04W 72/04

(52) U.S. Cl. 370/329

(57) ABSTRACT

Provided is a mobile station which can obtain an equivalent diversity effect in each communication scheme while keeping to an minimum the increase in the circuit scale of a mobile station even when the mobile station is compatible with a plurality of communication schemes. In a mobile station (100) which performs either single-carrier frequency-division multiple access (SC-FDMA) communication or orthogonal frequency division multiple access (OFDMA) communication, an interleaving unit (103) interleaves a plurality of resource elements, which are divided into a plurality of code blocks, in a plurality of code blocks when either SC-FDMA or OFDMA communication is performed. In addition, only when OFDMA communication is performed, a serial-to-parallel (SIP) converter (107) converts the data symbols to parallel streams and generates the OFDM symbols. A shifter (108) provides a different frequency shift to each OFDM symbol for the OFDM symbols input from the S/P converter (107), and distributes and places the plurality of resource elements of each plurality of code blocks after interleaving in the frequency domain.

### TECHNICAL FIELD

The present invention relates to a radio communication mobile station apparatus and a resource element distributed allocation method.

### BACKGROUND ART

3GPP RAN LTE (3rd Generation Partnership Project Radio Access Network Long Term Evolution) adopts OFDMA (Orthogonal Frequency Division Multiple Access) as a downlink communication scheme and adopts SC-FDMA (Single Carrier Frequency Division Multiple Access) as an uplink communication scheme (for example, see Non-Patent Literature 1.)

In addition, LTE-Advanced, which is developed LTE, studies application, of the space division multiplexing (SDM) technique where mobile stations transmit a plurality of transmission data via a plurality of antennas using the same frequency resource at the same time and a base station divides a plurality of spatially multiplexed signals, to improve the efficiency of use of uplink resources. Application of the SDM technique enables improvement of the efficiency of use of frequencies in the uplink.

However, combination of a single carrier communication scheme such as SC-FDMA and the SDM technique deteriorates reception characteristics as compared to combination of a multicarrier communication scheme such as OFDMA and the SDM technique (for example, see Non-Patent Literature 2). Therefore, LTE-Advanced is studying adopting OFDMA as well as SC-FDMA, as an uplink communication scheme.

Moreover, a mobile station interleaves coded transmission data to efficiently obtain coding gain. For example, a mobile station can obtain the time diversity effect by performing interleave processing on coded transmission data in the time domain, and also obtain the frequency diversity effect by performing interleave processing on coded transmission data in the frequency domain.

### CITATION LIST

### Non-Patent Literature

### [NPL 1] 3GPP TS 36.211 V8.1.0, “Physical Channels and Modulation (Release 8),” November 2007

[NPL 2] K. Higuchi, J. Kawamoto, H. Kawai, N. Maeda, M. Sawahashi, “Performance Comparisons Between OFDM and DS-CDMA Radio Access Using MIMO Multiplexing in Multi-path Fading Channels”, IEICE technical report CS2004-188, RSC2004-295, pp. 31-36, January 2005

### SUMMARY OF INVENTION

### Technical Problem

When interleaving coded transmission data, a mobile station performs interleave complying with the communication scheme used in data transmission.

For example, in SC-FDMA, one SC-OFDM symbol is composed of a plurality of time-continuous signals, and all frequency resources are occupied by these time-continuous signals. Therefore, it is possible to produce frequency diversity effect using SC-FDMA without interleave processing in the frequency domain. Thus, when using SC-FDMA, a mobile station performs interleave processing in the time domain to produce time diversity effect. That is, SC-FDMA allows both time diversity and frequency diversity effects only by interleave processing in the time domain.

By contract with this, in OFDMA, one OFDM symbol is composed of a plurality of subcarriers. Here, these subcarriers occupy only part of frequency resources. Therefore, when using OFDMA, interleave needs to be performed in the time domain and in the frequency domain to produce both time domain and frequency domain diversity effects.

Accordingly, when both SC-FDMA and OFDMA are adopted as uplink communication schemes, a mobile station must have an interleaver supporting SC-FDMA and an interleaver supporting OFDMA to support both communication schemes. However, this increases the circuit scale of a mobile station.

It is therefore an object of the present invention to provide a radio communication mobile station apparatus and a resource element (RE) distributed allocation method to allow the same frequency diversity effect between a plurality of communication schemes while minimizing increase in the circuit scale of a mobile station even if a mobile station supports the plurality of communication schemes.

### Solution to Problem

The radio communication mobile station apparatus according to the present invention that performs one of single carrier communication and multicarrier communication adopts a configuration to include: an interleaving section that interleaves a plurality of resource elements divided into a plurality of code blocks in the plurality of code blocks, in a case of whether the single carrier communication is performed or the multicarrier communication is performed; and an allocation section that distributed-allocates the plurality of resource elements after interleaving for each of the plurality of code blocks in a frequency domain, only when the multicarrier communication is performed.

### ADVANTAGEOUS EFFECTS OF INVENTION

According to the present invention, even if a mobile station supports a plurality of communication schemes, it is possible to produce the same diversity effect between communication schemes while minimizing increase in the circuit scale of a mobile station.

### BRIEF DESCRIPTION OF DRAWINGS

FIG. 1 is a block diagram showing a configuration of a mobile station according to Embodiment 1 of the present invention;

FIG. 2 is a block diagram showing a configuration of a base station according to Embodiment 1 of the present invention;

FIG. 3 is a drawing showing interleave processing according to Embodiment 1 of the present invention;

FIG. 4 is a drawing showing SC-FDMA signals according to Embodiment 1 of the present invention;

FIG. 5 is a drawing showing S/P conversion processing according to Embodiment 1 of the present invention;

FIG. 6 is a drawing showing frequency shifting processing according to Embodiment 1 of the present invention;

FIG. 7 is a drawing showing OFDMA signals according to Embodiment 1 of the present invention;

FIG. 8 is a block diagram showing a configuration of a mobile station according to Embodiment 2 of the present invention;

FIG. 9 is a drawing showing mirroring processing according to Embodiment 2 of the present invention;

FIG. 10 is a block diagram showing a configuration of a mobile station according to Embodiment 3 of the present invention;

FIG. 11 is a drawing showing randomizing processing according to Embodiment 3 of the present invention; and

FIG. 12 is a drawing showing OFDMA signals according to Embodiment 4 of the present invention.

### DESCRIPTION OF EMBODIMENTS

Now, embodiments of the present invention will be described in detail with reference to the accompanying drawings. In the following descriptions, uplink data transmitted from a mobile station (that is, uplink data received by a base station) is transmitted using SC-FDMA or OFDMA. That is, a mobile station performs either single carrier communication (SC-FDMA communication) or multicarrier communication (OFDMA communication).

### Embodiment 1

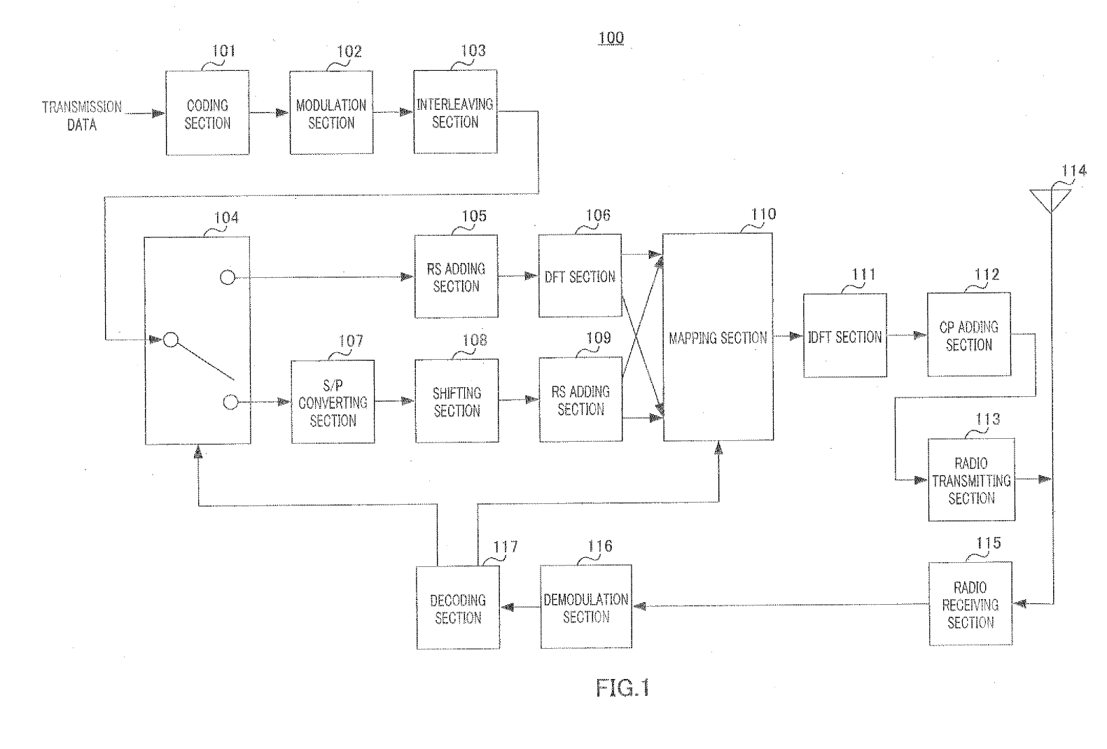

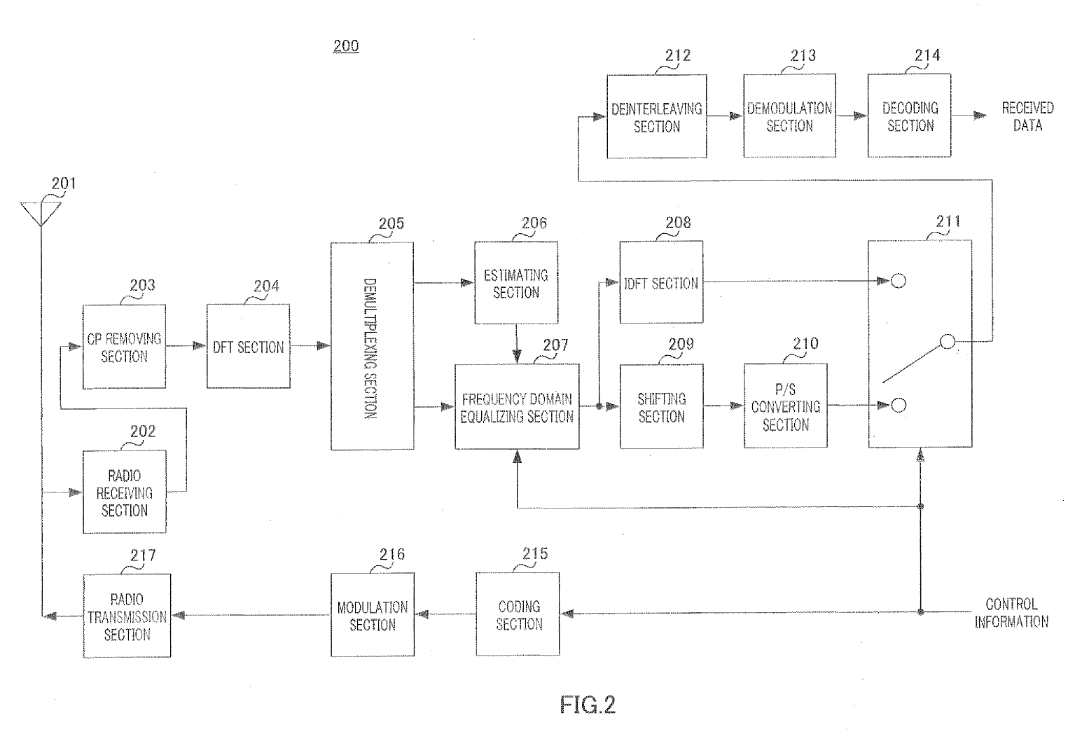

FIG. 1 shows the configuration of mobile station 100 according to the present embodiment, and FIG. 2 shows the configuration of base station 200 according to the present embodiment.

Here, to avoid complicated explanation, FIG. 1 shows components relating to uplink data transmission and components relating to downlink reception of control information, which are closely related to the present invention, and components associated with downlink data reception will not be illustrated or explained. Likewise, FIG. 2 shows components relating to uplink data reception and components relating to downlink transmission of control information, and components associated with downlink data transmission will not be illustrated or explained.

In addition, control information transmitted from base station 200 to mobile station 100 includes RB allocation information indicating transmission resources to allocate uplink data, and communication scheme switching command information indicating commands to switch between SC-FDMA and OFDMA communication schemes. For example, communication scheme switching command information indicates the communication scheme used in mobile station 100, which is either SC-FDMA communication or OFDMA communication scheme.

In addition, RS (reference signal) adding section 105 and DFT (discrete Fourier transform) section 106 in FIG. 1 and IDFT (inverse discrete Fourier transform) section 208 in FIG. 2 are components uniquely used in SC-FDMA communication. Likewise, S/P (serial/parallel) converting section 107, shifting section 108 and RS adding section 109 in FIG. 1 and shifting section 209 and P/S (parallel/serial) converting section 210 in FIG. 2 are components uniquely used in OFDMA communication.

In mobile station 100 shown in FIG. 1, transmission data (uplink data) is inputted to coding section 101. Here, transmission data is divided into code blocks, which are coding units, and composed of a plurality of code blocks. In addition, each code block is composed of a plurality of REs. In other words, a plurality of REs constituting transmission data are divided into a plurality of code blocks. Coding section 101 encodes each code block using an error detection code, for example, a CRC (cyclic redundancy check) code. In addition, coding section 101 performs interleave processing on a plurality of REs in each code block (intra-subblock interleaving). Then, coding section 101 outputs coded transmission data to modulation section 102.

Modulation section 102 modulates transmission data inputted from coding section 101 to generate data symbols. Then, modulation section 102 outputs generated data symbols to interleaving section 103.

Whether SC-FDMA communication is performed or OFDMA communication is performed, interleaving section 103 interleaves data symbols (SC-FDMA symbols or OFDM symbols) inputted from modulation section 102 in code blocks. To be more specific, whether SC-FDMA communication is performed or OFDMA communication is performed, interleaving section 103 interleaves data symbols, that is, a plurality of REs divided into a plurality of code blocks in a plurality of code blocks. That is, interleaving section 103 interleaves a plurality of REs in the time domain. For example, interleaving section 103 performs interleave processing by rearranging a plurality of REs in the time domain such that neighboring REs among a plurality of REs are allocated to different SC-FDMA symbols or different OFDM symbols. Then, interleaving section 103 outputs interleaved data symbols to switch 104.

Switch 104 switches between the connection to RS adding section 105 and the connection to S/P converting section 107, according to communication scheme switching command information inputted from decoding section 117. To be more specific, when the communication scheme indicated by communication scheme switching command information is the SC-FDMA communication, switch 104 connects to RS adding section 105 to output a data symbol inputted from interleaving section 103 to RS adding section 105. On the other hand, when the communication scheme indicated by communication scheme switching command information is OFDMA communication, switch 104 connects to S/P converting section 107 to output data symbols inputted from interleaving section 103 to S/P converting section 107.

RS adding section 105 adds an RS to data symbols (i.e. SC-FDMA symbols) inputted from switch 104 by time-multiplexing. Then, RS adding section 105 outputs a signal with an RS (SC-FDMA signal) to DFT section 106.

DFT section 106 applies DFT processing to the SC-FDMA signal inputted from RS adding section 105 and converts the time domain signal to a frequency domain signal. Then, DFT section 106 outputs the SC-FDMA signal after DFT to mapping section 110.

Meanwhile, S/P converting section 107 converts data symbols in parallel, which are serially inputted from switch 104. To be more specific, S/P converting section 107 generates an OFDM symbol by associating data symbols serially inputted, with a plurality of subcarriers constituting the OFDM symbol. That is, S/P converting section 107 transforms a plurality of time domain REs interleaved in interleaving section 103 into frequency domain REs to generates an OFDM symbol. Then, S/P converting section 107 outputs the OFDM symbol to shifting section 108.

Shifting section 108 shifts OFDM symbols inputted from S/P converting section 107 on a per OFDM symbol basis in the frequency domain, using a different shift value for each OFDM symbol. For example, shifting section 108 uses the shift value (the number of subcarriers) calculated by following equation (1).

Shift value=(n−1)×Nsub/Nsym (1)

Here, Nsub represents the number of subcarriers used in OFDMA communication, and Nsym represents the number of information symbols to allocate transmission data to, of the number of OFDM symbols per slot. In addition, symbol number n ranges from 1 to Nsym. That is, a plurality of REs constituting an OFDM symbol of symbol number n are shifted with the shift value (the number of subcarriers) calculated by the above equation (1). Then, shifting section 108 outputs the OFDM symbol after frequency shifting to RS adding section 109.

RS adding section 109 adds an RS to OFDM symbols inputted from shifting section 108 by time-multiplexing, in the same way as in RS adding section 105. Then, RS adding section 109 outputs an RS added-signal (OFDMA signal) to mapping section 110.

Mapping section 110 maps an SC-FDMA signal inputted from DFT section 106 or an OFDMA signal inputted from RS adding section 109 to subcarriers, according to RB allocation information inputted from decoding section 117. Then, mapping section 110 outputs the signal mapped to subcarriers to IDFT section 111.

IDFT section 111 applies IDFT processing to the signal inputted from mapping section 110 and outputs the signal after IDFT to CP (cyclic prefix) adding section 112.

CP adding section 112 adds the same signal as the end part of the signal inputted from IDFT section 111, to the beginning of the signal as a CP.

Radio transmitting section 113 performs transmission processing including D/A conversion, amplification, up-conversion and so forth, on the signal inputted from CP adding section 112, and transmits the signal after transmission processing, from antenna 114, to base station 200 (FIG. 2).

Meanwhile, radio receiving section 115 receives control information transmitted from base station 200 (FIG. 2) via antenna 114 and performs reception processing on this control information, including down-conversion, A/D conversion and so forth. Radio receiving section 115 outputs the control information after reception processing to demodulation section 116.

Demodulation section 116 demodulates the control information inputted from radio receiving section 115 and outputs the demodulated control information to decoding section 117.

Decoding section 117 decodes control information inputted from demodulation section 116, and, of decoded control information, outputs RB allocation information to mapping section 110 and outputs communication scheme switching command information to switch 104.

Next, in base station 200 shown in FIG. 2, radio receiving section 202 receives a signal (SC-FDMA signal or OFDMA signal) transmitted from mobile station 100 (FIG. 1) via antenna 201 and performs reception processing on the received signal, including down-conversion, A/D conversion and so forth. Radio receiving section 202 outputs the received signal after reception processing to CP removing section 203.

CP removing section 203 removes the CP from the received signal after reception processing.

DFT section 204 applies DFT processing to the received signal inputted from CP removing section 203 and transforms the time domain signal to a frequency domain signal. Then, DFT section 204 outputs the signal after DFT, that is, a frequency domain signal, to demultiplexing section 205.

Demultiplexing section 205 demultiplexes the signal inputted from DFT section 204 to data signals and an RS. Then, demultiplexing section 205 outputs the RS to estimating section 206 and outputs the data signals to frequency domain equalizing section 207.

Estimating section 206 performs channel estimation using the RS inputted from demultiplexing section 205. Then, estimating section 206 outputs channel information indicating the estimation result to frequency domain equalizing section 207.

Frequency domain equalizing section 207 equalizes data signals inputted from demultiplexing section 205 in the frequency domain using the channel information inputted from estimating section 206. Then, frequency domain equalizing section 207 outputs data signals after frequency domain equalization to IDFT section 208 or shifting section 209, according to inputted control information. To be more specific, when the communication scheme indicated by communication scheme switching command information included in control information is SC-FDMA communication, frequency domain equalizing section 207 outputs data signals (i.e. an SC-FDMA signal) to IDFT section 208. On the other hand, when the communication scheme indicated by communication scheme switching command information included in control information is OFDMA communication, frequency domain equalizing section 207 outputs data signals (i.e. an OFDMA signal) to shifting section 209.

IDFT section 208 applies IDFT processing to the SC-FDMA signal inputted from frequency domain equalizing section 207 and converts the frequency domain signal to a time domain signal. Then, IDFT section 208 sequentially outputs time domain SC-FDMA signals to switch 211.

Meanwhile, shifting section 209 shifts an OFDMA signal inputted from frequency domain equalizing section 207 using a shift value having an opposite characteristic to the shift value used to shift an OFDM symbol in shifting section 108 (FIG. 1) in mobile station 100. For example, shifting section 209 applies, to an OFDM symbol of symbol number n included in an OFDMA signal, the shift value (the number of subcarriers), which is the same as the shift value calculated by equation 1 in the opposite direction to the shift value in shifting section 108. Then, shifting section 209 outputs the shifted OFDMA signal to P/S converting section 210. P/S converting section 210 serially converts the OFDMA signal inputted from shifting section 209, that is a signal in which a plurality of REs are allocated in the frequency domain. Then, P/S converting section 210 sequentially outputs the plurality of REs allocated in the frequency domain, to switch 211.

Switch 211 switches between the connection to IDFT section 208 and the connection to P/S converting section 210, according to communication scheme switching command information included in inputted control information. To be more specific, when the communication scheme indicated by communication scheme switching command information is SC-FDMA communication, switch 211 outputs an SC-TDMA signal inputted from IDFT section 208 to deinterleaving section 212 by connecting to IDFT section 208. On the other hands, when the communication scheme indicated by communication scheme switching command information is OFDMA communication, switch 211 outputs an OFDMA signal inputted from P/S converting section 210 to deinterleaving section 212 by connecting to P/S converting section 210.

Deinterleaving section 212 deinetrleaves data signals (an SC-FDMA signal or OFDMA signal) inputted from switch, 211. To be more specific, whether SC-FDMA communication is performed or OFDMA communication is performed, deinterleaving section 212 performs deinterleave processing using the same interleave pattern as in interleaving section 103 (FIG. 1) in mobile station 100. Then, deinterleaving section 212 outputs data signals after deinterleaving to demodulation section 213. That is, deinterleaving section 212 performs the same interleave processing on both data signals of SC-FDMA communication and OFDMA communication, in the same way as in interleaving section 103 (FIG. 1).

Demodulation section 213 demodulates data signals inputted from deinterleaving section 212 and outputs the data signals after demodulation to decoding section 214.

Decoding section 214 decodes data signals inputted from decoding section 213 and outputs decoded data signals as received data.

Meanwhile, coding section 215 encodes inputted control information and outputs coded control information to modulation section 216.

Modulation section 216 modulates control information inputted from coding section 215 and modulated control information to radio transmitting section 217.

Radio transmitting section 217 performs transmission processing including D/A conversion, amplification and up-conversion and so forth, on control information inputted from modulation section 216, and transmits control information after transmission processing from antenna 201 to mobile station 100 (FIG. 1).

Next, SC-FDMA communication processing and OFDMA communication processing in mobile station 100 according to the present embodiment will be described in detail. Here, one slot is composed of seven SC-FDMA symbols or seven OFDM symbols. In addition, transmission data is divided into six code blocks (code blocks 1 to 6). Moreover, each code block is composed of twelve REs (REs 1 to 12), which are interleaved in each code block (intra-subblock interleaving). To be more specific, transmission data is composed of seventy-two REs, and these seventy-two REs are divided into six code blocks. In addition, among seven symbols (symbol numbers 1 to 7) in one slot, an RS is allocated to one symbol and code blocks 1 to 6 are allocated to the remaining six symbols in one slot. That is, the number of information symbols Nsym in one slot is six. Here, an RS is allocated to the symbol of symbol number 4, which is located in the center of one slot. In addition, one SC-FDMA symbol contains twelve time-continuous signals. Moreover, one OFDM symbol contains twelve subcarriers (the subcarriers of subcarrier indexes 1 to 12). Furthermore, a CP portion in transmission data will not be illustrated in the following descriptions for ease of explanation.

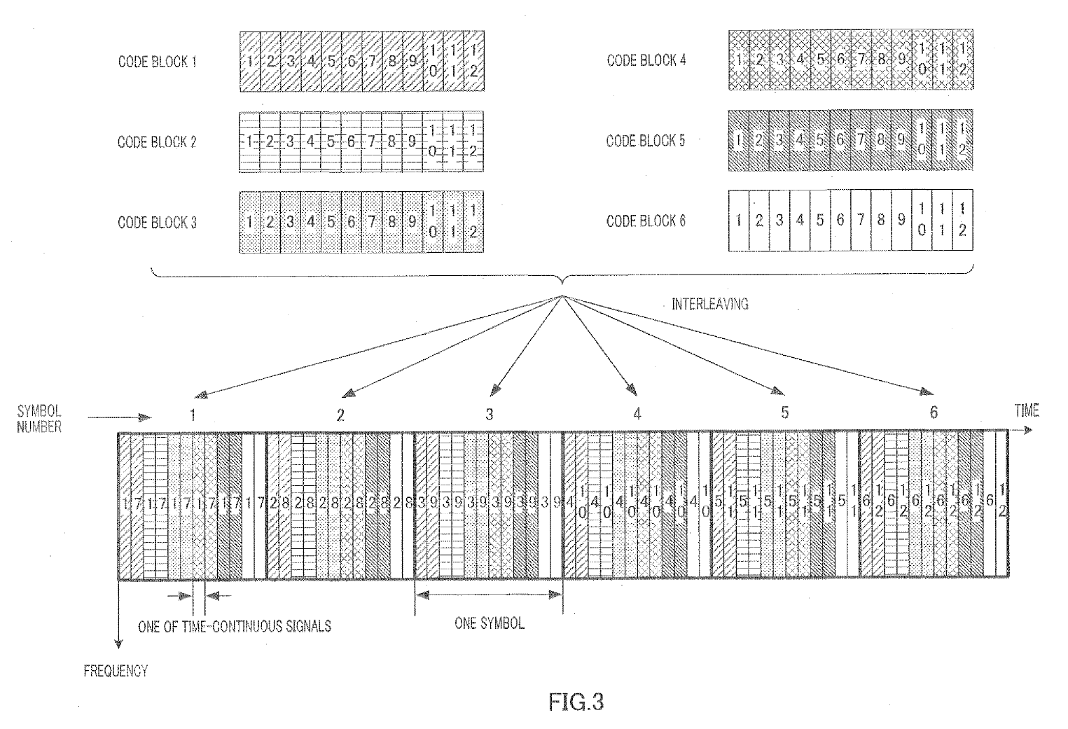

First, interleaving section 103 interleaves REs divided into each code block in code blocks 1 to 6. To be more specific, as shown in FIG. 3, interleaving section 103 allocates REs 1 to 12 in each of code block 1 to 6, to any time-continuous signals constituting the symbols of symbol numbers 1 to 6. For example, as shown in FIG. 3, interleaving section 103 allocates RE 1 and RE 7 in code block 1 to the time-continuous signals in the symbol of symbol number 1; allocates RE 2 and RE 8 in code block 1 to the time-continuous signals in the symbol of symbol number 2; allocates RE 3 and RE 9 in code block 1 to the time-continuous signals in the symbol of symbol number 3; allocates RE 4 and RE 10 in code block 1 to the time-continuous signals in the symbol of symbol number 4; allocates RE 5 and RE 11 in code block 1 to the time-continuous signals in the symbol of symbol number 5; and allocates RE 6 and RE 12 in code block 1 to the time-continuous signals in the symbol of symbol number 6. The same applies to code blocks 2 to 6.

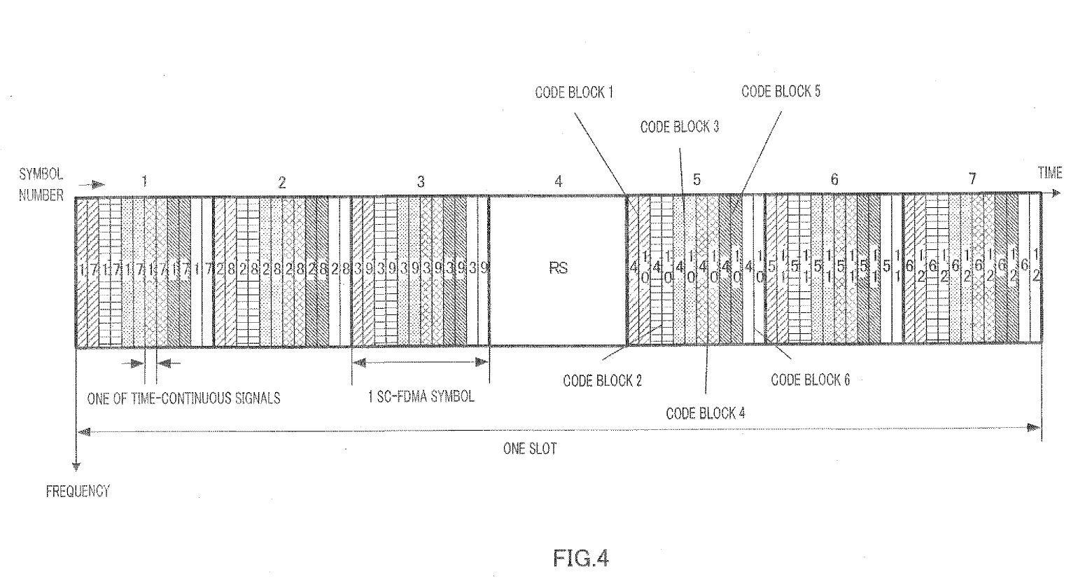

Next, when mobile station 100 performs SC-FDMA communication (when the communication scheme indicated by communication scheme switching command information is SC-FDMA communication), RS adding section 105 adds an RS to the SC-FDMA symbol of symbol number 4 located in the center of one slot, as shown in FIG. 4. That is, as shown in FIG. 4, RS adding section 105 shifts the SC-FDMA symbols of symbol numbers 4 to 6 shown in FIG. 3, which are inputted from interleaving section 103, to the SC-FDMA symbols of symbol numbers 5 to 7, and adds an RS to the SC-FDMA symbol of symbol number 4 shown in FIG. 4.

By this means, as for the SC-FDMA signal shown in FIG. 4, seventy-two REs divided into code blocks 1 to 6 are distributed-allocated in the time domain (the SC-FDMA symbols of symbol numbers 1 to 3 and the SC-FDMA symbols of symbol numbers 5 to 7.) Therefore, even if an RS is located in the center of a slot (the SC-FDMA symbol of symbol number 4 shown in FIG. 4), the influence of variations in the accuracy of channel estimation among SC-FDMA symbols (the SC-FDMA symbols of symbol numbers 1 to 7 shown in FIG. 4) is equalized among code blocks 1 to 6. To be more specific, it is possible to produce time diversity effect when SC-FDMA communication is performed. In addition, as shown in FIG. 4, time-continuous signals occupy all frequency resources, so that it is possible to produce frequency diversity effect.

On the other hand, when mobile station 100 performs OFDMA communication (when the communication scheme indicated by communication scheme switching command information is OFDMA communication), S/P converting section 107 and shifting section 108 function as an allocation means to distributed-allocate a plurality of interleaved REs for each of a plurality of code blocks in the frequency domain.

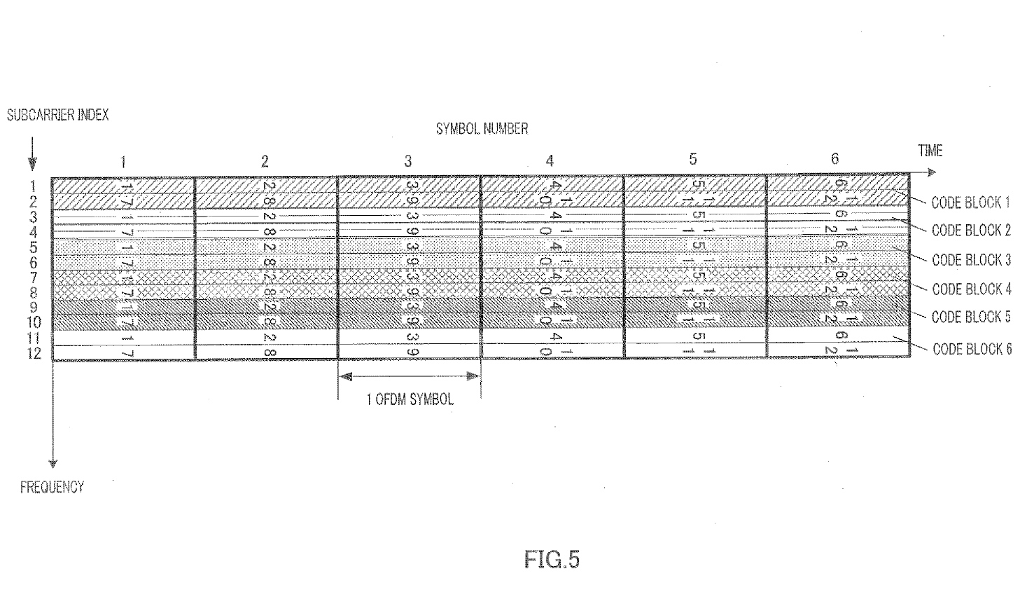

S/P converting section 107 converts REs in parallel on a per subcarrier basis, which constitute the symbols of symbol numbers 1 to 6 shown in FIG. 3. To be more specific, S/P converting section 107 associates twelve REs (REs 1 and 7 in each code blocks 1 to 6) constituting the symbol of symbol number 1 shown in FIG. 3, with the subcarriers of subcarrier indexes 1 to 12 constituting the OFDM symbol of symbol number 1, as shown in FIG. 5. For example, as shown in FIG. 5, REs 1 and 7 in code block 1 are associated with the subcarriers of subcarrier indexes 1 and 2 in the OFDM symbol of symbol number 1, respectively. In addition, for example, REs 1 and 7 in code block 2 are associated with the subcarriers of subcarrier indexes 3 and 4 in the OFDM symbol of symbol number 1, respectively. The same applies to the OFDM symbols of symbol numbers 2 to 6 shown in FIG. 5. By this means, a plurality REs interleaved in the time domain by interleaving section 103 are allocated in the frequency domain.

Next, shifting section 108 shifts the OFDM symbols after S/P conversion shown in FIG. 5 on a per OFDM symbol basis, in the frequency domain, using a different shift value on a per OFDM symbol basis. Here, the number of subcarriers constituting an OFDM symbol is twelve (Nsub=12), and the number of information symbols (that is, the number of symbols to allocate code blocks) per slot is six (Nsym=6). Therefore, the shift value (the number of subcarriers) calculated by equation (1) is (n−1)×2(=(n−1)×12/6) subcarriers. In addition, since Nsym is six, n ranges from 1 to 6.

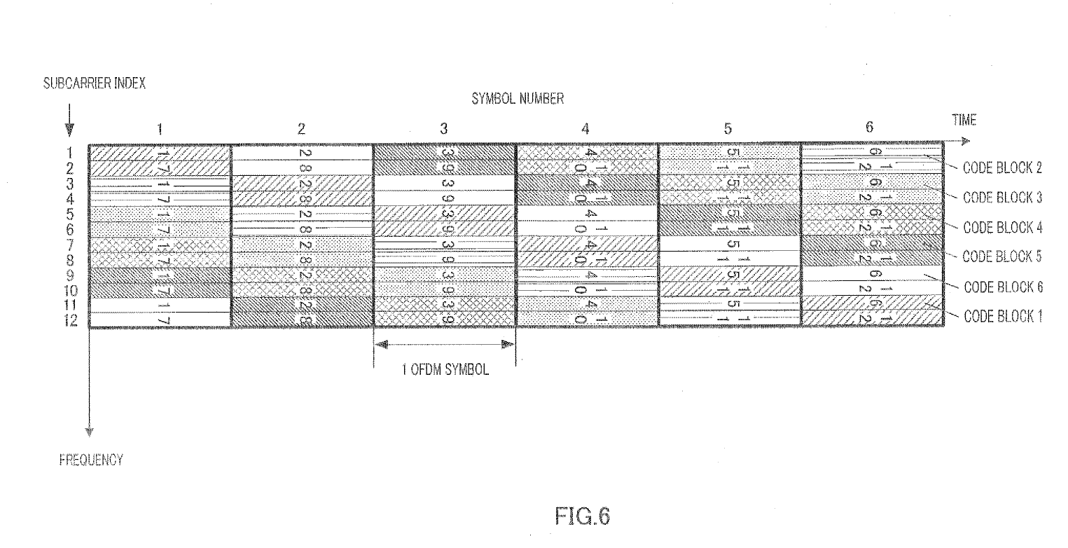

Accordingly, as shown in FIG. 6, shifting section 108 does not provide frequency shift to the OFDM symbol of symbol number 1 (n=1) because the shift value is 0 (=(1−1)×2). In addition, shifting section 108 shifts REs in the OFDM symbol of symbol number 2 (n=2) using the subcarrier shift value of 2(=(2−1)×2), and shifts. REs in the OFDM symbol of symbol number 3 (n=3) using the subcarrier shift value of 4(=(3-1)×2). The same applies to the OFDM symbols of symbol numbers 4 to 6.

In FIG. 6, for example, paying attention to code block 1, RE 1 and RE 7 are allocated to the subcarriers of subcarrier indexes 1 and 2 in the OFDM symbol of symbol number 1; RE 2 and RE 8 are allocated to the subcarriers of subcarrier indexes 3 and 4 in the OFDM symbol of symbol number 2; RE 3 and RE 9 are allocated to the subcarriers of subcarrier indexes 5 and 6 in the OFDM symbol of symbol number 3; RE 4 and RE 10 are allocated to the subcarriers of subcarrier indexes 7 and 8 in the OFDM symbol of symbol number 4; RE 5 and RE 11 are allocated to the subcarriers of subcarrier indexes 9 and 10 in the OFDM symbol of symbol number 5; and RE 6 and RE 12 are allocated to the subcarriers of subcarrier indexes 11 and 12 in the OFDM symbol of symbol number 6. That is, RE 1 to RE 12 in code block 1 shown in FIG. 6 are allocated to all the subcarriers of subcarrier indexes 1 to 12 over the OFDM symbols of symbol numbers 1 to 6. The same applies to code blocks 2 to 6. That is, shifting section 108 evenly distributed-allocates a plurality of REs over one slot, for each of code blocks 1 to 6 in the frequency domain.

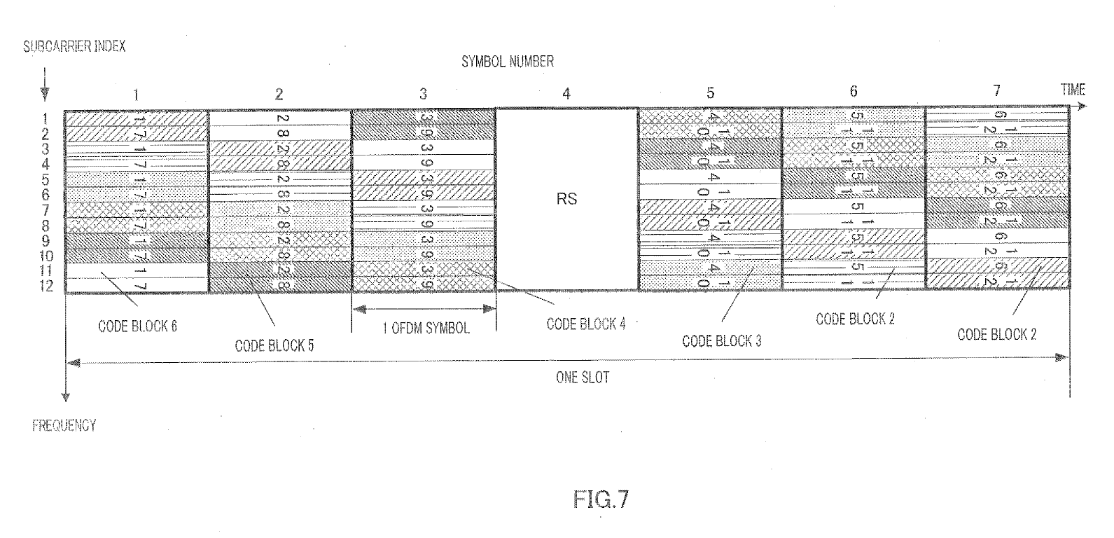

Then, like RS adding section 105, RS adding section 109 adds an RS to the OFDM symbol of symbol number 4 located in the center of one slot, as shown in FIG. 7. That is, RS adding section 109 shifts the OFDM symbols of symbol numbers 4 to 6 shown in FIG. 6 to the OFDM symbols of symbol numbers 5 to 7, as shown in FIG. 7, and adds an RS to the OFDM symbol of symbol number 4 shown in FIG. 7.

As described above, in the OFDMA signal shown in FIG. 7, seventy-two REs divided into code blocks 1 to 6 are distributed-allocated in the time domain (the OFDM symbols of symbol numbers 1 to 3 and the OFDM symbols of symbol numbers 5 to 7) by interleaving section 103, and distributed-allocated in the frequency domain (the subcarriers of subcarrier indexes 1 to 12) per code block by S/P converting section 107 and shifting section 108. For example, as shown in FIG. 7, as for code block 1, REs are evenly allocated to the OFDM symbols of symbol numbers 1 to 3 and the OFDM symbols of symbol numbers 5 to 7 every two REs in the time domain, and REs are evenly allocated to the subcarriers of subcarrier indexes 1 to 12 per RE in the frequency domain. Therefore, even if mobile station 100 performs OFDMA communication, it is possible to produce both time diversity and frequency diversity effects.

As described above, mobile station 100 uses interleaved data symbols (the symbols of symbol numbers 1 to 6 shown in FIG. 3) as is, which are obtained in interleaving section 103, as SC-FDMA symbols. Meanwhile, mobile station 100 uses interleaved data symbols obtained in interleaving section 103 as OFDM symbols shown in FIG. 5, by performing S/P conversion in S/P converting section 107. That is, mobile station 100 uses interleaving section 103 to interleave each data symbol whether SC-FDMA communication is performed or OFDMA communication is performed. That is, mobile station 100 can share interleaving section 103 between SC-FDMA communication and OFDMA communication.

Here, since interleaving section 103 performs interleaving only in the time domain, REs after S/P conversion are allocated to only part of subcarriers in the frequency domain although they are evenly distributed-allocated on a per code block basis in the time domain as shown in FIG. 5. Therefore, only when mobile station 100 performs OFDMA communication, a plurality of interleaved REs are shifted on a per OFDM symbol basis, using a different shift value on a per OFDM symbol basis in the frequency domain. By this means, even if mobile station 100 performs OFDMA communication, a plurality of REs are distributed-allocated on a per code block basis in the frequency domain, so that it is possible to produce the frequency diversity effect. That is, with OFDMA communication, it is possible to produce both time diversity and frequency diversity effects in the same way as in SC-FDMA communication. In addition, a simple configuration using S/P conversion processing and shift processing allows a plurality of REs interleaved in the time domain to be distributed-allocated in the frequency domain.

As described above, according to the present embodiment, whether SC-FDMA communication is performed or OFDMA communication is performed, a mobile station interleaves a plurality of REs in a plurality of code blocks (i.e. in the time domain) using an interleaver (interleaving section 103 shown in FIG. 1) shared between SC-FDMA communication and OFDMA communication. Therefore, it is not necessary to provide an interleaver to produce the time diversity effect per communication scheme, so that it is possible to avoid increase in the circuit scale of mobile station 100. In addition, only when OFDMA communication is performed, a mobile station shifts a plurality of REs on a per OFDM symbol basis in the frequency domain, using a different shift value on a per OFDM symbol basis. By this means, since a plurality of REs are evenly distributed-allocated per code block in the frequency domain, it is possible to produce frequency diversity effect even in OFDMA communication. That is, it is possible to produce time diversity and frequency effects using both SC-FDMA communication and OFDMA communication schemes by sharing an interleaver between SC-FDMA communication and OFDMA communication. In addition, a mobile station distributed-allocates a plurality of REs in the frequency domain only by a simple configuration including S/P conversion processing and frequency shift processing, so that it is possible to minimize increase in the circuit scale of a mobile station to produce frequency diversity effect. Therefore, according to the present invention, even if a mobile station supports a plurality of communication schemes, it is possible to produce the same diversity effect between a plurality of communication schemes while minimizing increase in the circuit scale of the mobile station.

### Embodiment 2

With the present embodiment, only when OFDMA communication is performed, a mobile station allocates a plurality of interleaved REs such that each of a plurality of code blocks holds the mirror-image relationship in the frequency domain, with respect to the center location in a plurality of OFDM symbols each composed of a plurality of REs in the time domain.

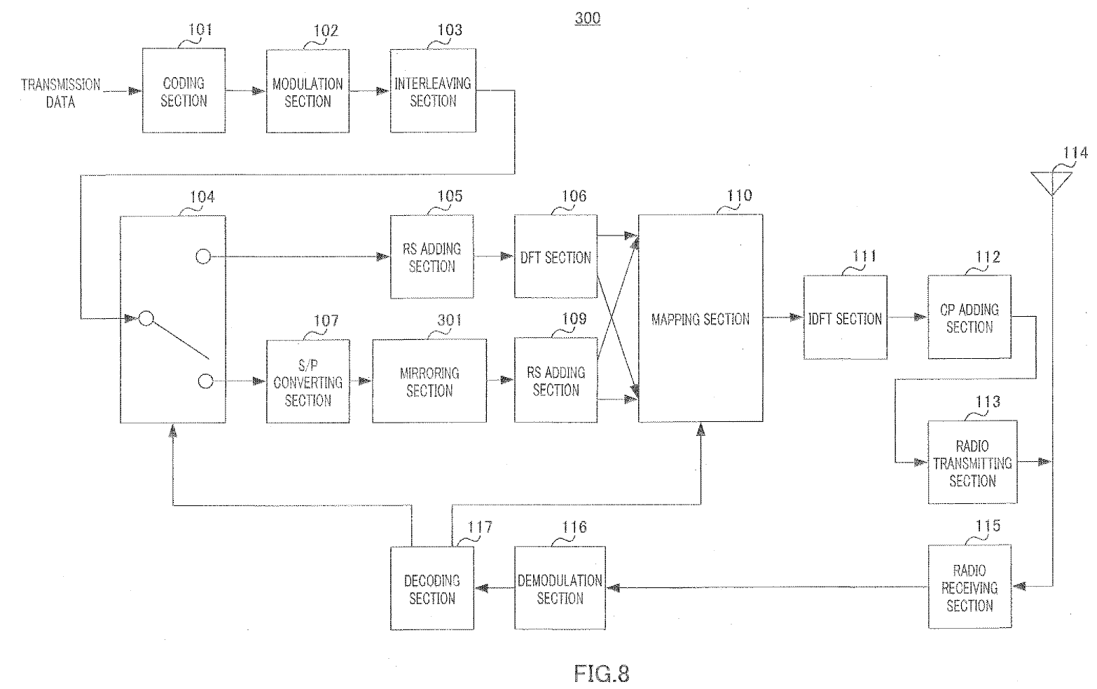

FIG. 8 shows the configuration of mobile station 300 according to the present embodiment. Here, in FIG. 8, the same components as in FIG. 1 (Embodiment 1) are assigned the same reference numerals and descriptions will be omitted.

In mobile station 300 shown in FIG. 8, S/P converting section 107 and mirroring section 301 function as an allocation means to distributed-allocate a plurality of interleaved REs for each of a plurality of code blocks only when OFDMA communication is performed.

Mirroring section 301 is a component uniquely used in OFDMA communication. Mirroring section 301 performs mirroring processing on. OFDM symbols inputted from S/P converting section 107. To be more specific, mirroring section 301 allocates a plurality of REs such that each of a plurality of code blocks holds the mirror-image relationship, with respect to the center location in a plurality of OFDM symbols in the time domain. Then, mirroring section 301 outputs OFDM symbols after mirror processing to RS adding section 109.

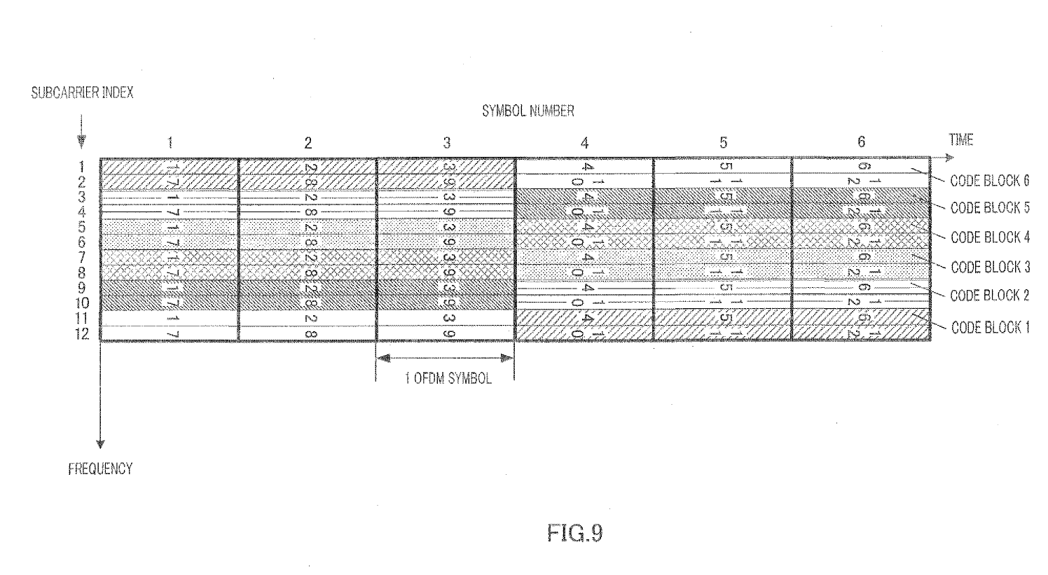

FIG. 9 shows an example of mirroring processing in mirroring section 301 in mobile station 300. In the following descriptions, one slot is composed of seven OFDM symbols in the same way as in Embodiment 1. In addition, transmission data is divided into six code blocks (code blocks 1 to 6), and each code block is composed of twelve REs (REs 1 to 12), which are interleaved in each code block. In other words, transmission data is composed of seventy-two REs and these seventy-two REs are divided into six code blocks. In addition, among seven symbols in one slot, an RS is allocated to one symbol, and code blocks 1 to 6 are allocated to six symbols. Moreover, one OFDM symbol contains twelve subcarriers (subcarriers of subcarrier indexes 1 to 12.)

Mirroring section 301 performs mirroring processing on OFDM symbols shown in FIG. 5. For example, mirroring section 301 allocates REs 1 to 12 in each of code blocks 1 to 6 shown in FIG. 5 such that each of code blocks holds the mirror-image relationship, with respect to the center location in the OFDM symbols of symbol numbers 1 to 6 in the time domain, that is, the boundary between the OFDM symbol of symbol number 3 and the OFDM symbol of symbol number 4. To be more specific, as shown in FIG. 9, for the OFDM symbols of symbol numbers 1 to 3, mirroring section 301 allocates REs 1 to 3 and REs 7 to 9 in each of code blocks 1 to 6, to the subcarriers of subcarrier indexes 1 to 12, like the OFDM symbols of symbol numbers 1 to 3 shown in FIG. 5.

By contrast with this, for the OFDM symbols of symbol numbers 4 to 6 shown in FIG. 9, mirroring section 301 allocates REs 4 to 6 and REs 10 to 12 in code block 1, to the subcarriers of subcarrier indexes 11 and 12 (the subcarriers to hold the mirror-image relationship with the subcarriers of subcarrier indexes 1 and 2 in the OFDM symbols of symbol numbers 1 to 3 to which REs 1 to 3 and REs 7 to 9 in code block 1 are allocated), respectively. Likewise, for the OFDM symbols of symbol numbers 4 to 6 shown in FIG. 9, mirroring section 301 allocates REs 4 to 6 and RE 10 to 12 in code block 2, to the subcarriers of subcarrier indexes 9 and 10 (the subcarriers to hold the mirror-image relationship with the subcarriers of subcarrier indexes 3 and 4 in the OFDM symbols of symbol numbers 1 to 3 to which REs 1 to 3 and REs 7 to 9 in code block 2 are allocated), respectively. The same applies to code blocks 3 to 6.

As shown in FIG. 9, for the OFDM symbols of symbol numbers 1 to 3, REs for code blocks 1 to 6 are allocated to subcarriers in ascending order from the subcarrier of subcarrier index 1. By contrast with this, for the OFDM symbols of symbol numbers 4 to 6, REs for code blocks 1 to 6 are allocated to subcarriers in descending order from the subcarrier of subcarrier index 12. That is, seventy-two REs divided into code blocks 1 to 6 are allocated to subcarriers to hold the mirror-image relationship per code block, with respect to the location (center location) between the OFDM symbols of symbol numbers 1 to 3 and the OFDM symbols of symbol numbers 4 to 6. By this means, mobile station 300 can distributed-allocate a plurality of REs per code block over the OFDM symbols of symbol numbers 1 to 6 in the frequency domain, and therefore provide frequency diversity effect.

In addition, mirroring section 301 leaves one group of OFDM symbols (the OFDM symbols of symbol numbers 1 to 3 shown in FIG. 5) as is, of the OFDM symbols inputted from S/P converting section 107 (the OFDM symbols of symbol numbers 1 to 6 shown in FIG. 5), and performs mirroring processing on only the other group of OFDM symbols (the OFDM symbols 4 to 6 shown in FIG. 5) making the mirror-image relationship with the one group of OFDM symbols. As a result of this, mobile station 300 can produce frequency diversity effect using an easier configuration than the is configuration using shift processing in Embodiment 1.

In this way, according to the present embodiment, a plurality of REs are distributed-allocated for each of a plurality of code blocks in the frequency domain by performing mirroring processing. Therefore, according to the present embodiment, it is possible to produce the same diversity effect between a plurality of communication schemes in the same way as in Embodiment 1. In addition, mirroring processing in the present embodiment enables the frequency diversity effect with an easier configuration than the configuration using shift processing in Embodiment 1, so that it is possible to avoid increase in the circuit scale of a mobile station further, as compared to Embodiment 1.

### Embodiment 3

With the present embodiment, a mobile station randomly allocates a plurality of interleaved REs for each of a plurality of code blocks in the frequency domain.

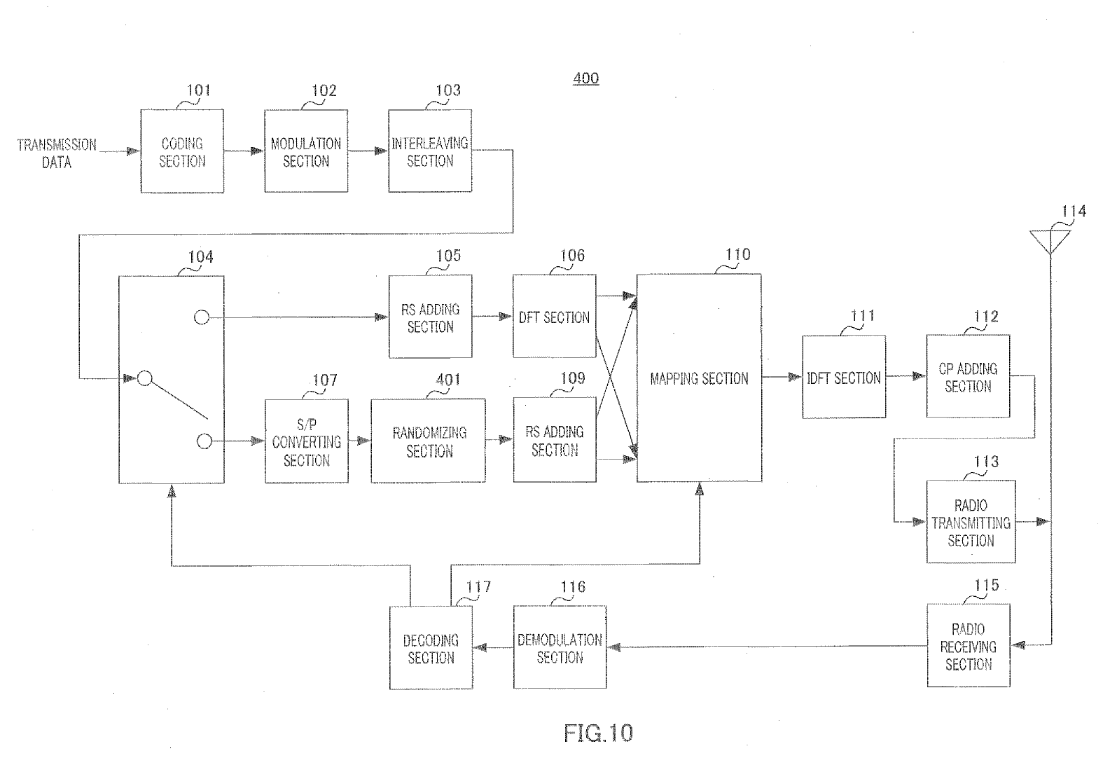

FIG. 10 shows a configuration of mobile station 400 according to the present embodiment. Here, in FIG. 10, the same components as in FIG. 1 (Embodiment 1) are assigned the same reference numerals and descriptions will be omitted.

In mobile station 400 shown in FIG. 10, S/P converting section 107 and randomizing section 401 function as an allocation means to distributed-allocate a plurality of interleaved REs for each of a plurality of code blocks, only when OFDMA communication is performed.

Randomizing section 401 is a component uniquely used in OFDMA communication. Randomizing section 401 performs randomizing processing on OFDM symbols inputted from S/P converting section 107. To be more specific, randomizing section 401 randomly allocates a plurality of REs for each of a plurality of code blocks in the frequency domain. Then, randomizing section 401 outputs randomized OFDM symbols to RS adding section 109.

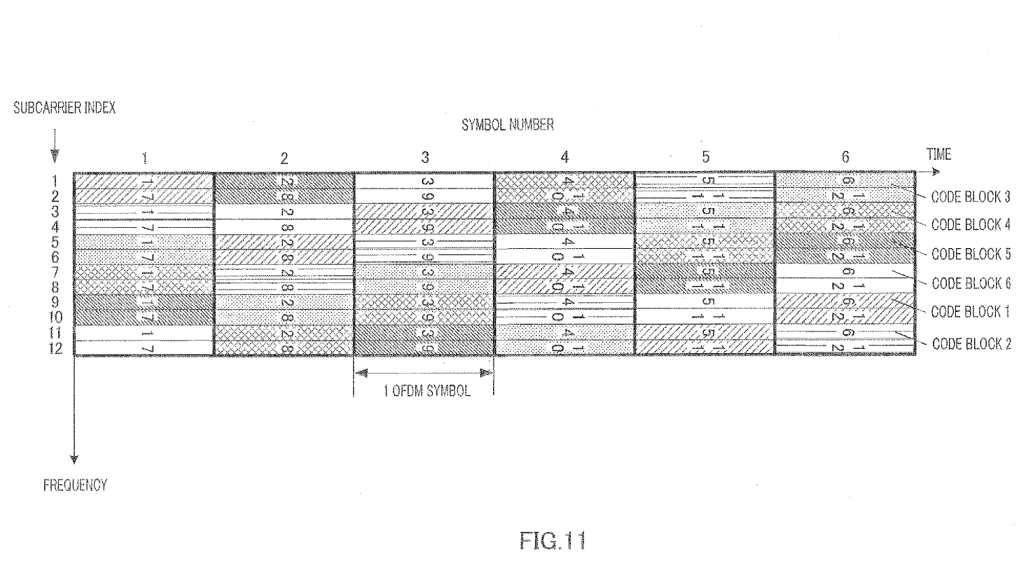

FIG. 11 shows an example of randomizing processing in randomizing section 401 in mobile station 400. In the following descriptions, one slot is composed of seven OFDM symbols in the same way as in Embodiment 1. In addition, transmission data is divided into six code blocks (code blocks 1 to 6). Moreover, each code block is composed of twelve REs (REs 1 to 12), which are interleaved in each code block (intra-subblock interleaving). To be more specific, transmission data is composed of seventy-two REs and these seventy-two REs are divided into six code blocks. In addition, among seven symbols in one slot, an RS is allocated to one symbol, and code blocks 1 to 6 are allocated to six symbols. In addition, one OF DM symbol contains twelve subcarriers (the subcarriers of subcarrier indexes 1 to 12).

Randomizing section 401 performs randomizing processing on OFDM symbols shown in FIG. 5. For example, randomizing section 401 randomly allocates seventy-two REs arranged in the OFDM symbols of symbol numbers 1 to 6 shown in FIG. 5, to the subcarriers of subcarrier indexes 1 to 12 for each of code blocks 1 to 6. For example, as shown in FIG. 11, for code block 1, randomizing section 401 allocates REs 1 and 7 to the subcarriers of subcarrier indexes 1 and 2 in the OFDM symbol of symbol number 1; allocates REs 2 and 8 to the subcarriers of subcarrier indexes 5 and 6 in the OFDM symbol of symbol number 2; allocates REs 3 and 9 to the subcarriers of subcarrier indexes 3 and 4 in the OFDM symbol of symbol number 3; allocates REs 4 and 10 to the subcarriers of subcarrier indexes 7 and 8 in the OFDM symbol of symbol number 4; allocates REs 5 and 11 to the subcarriers of subcarrier indexes 11 and 12 in the OFDM symbol of symbol number 5; and allocates REs 6 and 12 to the subcarriers of subcarrier indexes 9 and 10 in the OFDM symbol of symbol number 6. The same applies to code blocks 2 to 6.

As described above, randomizing section 401 randomly allocates seventy-two REs to the subcarriers of subcarrier indexes 1 to 12 for each of code blocks 1 to 6 over the OFDM symbols of symbol numbers 1 to 6. By this means, mobile station 400 can distributed-allocate a plurality of REs for each of a plurality of code blocks in the frequency domain. That is, it is possible to produce frequency diversity effect in the same way as in Embodiment 1.

As described above, according to the present embodiment, a plurality of REs constituting an OFDM symbol are distributed-allocated on a random basis for each of a plurality of code blocks in the frequency domain, so that it is possible to produce the same effect as in Embodiment 1.

Here, with the present embodiment, although the allocation example shown in FIG. 11 has been described as an example of randomizing processing, the randomizing processing according to the present invention is not limited to the allocation example shown in FIG. 11.

### Embodiment 4

With the present embodiment, when performing OFDMA communication, a mobile station distributed-allocates a plurality of interleaved REs in one OFDM symbol per code block in the frequency domain.

Now, this will be described in detail. In the following descriptions, one slot is composed of seven OFDM symbols in the same way as in Embodiment 1. In addition, transmission data is divided into six code blocks (code blocks 1 to 6). Moreover, each code block is composed of twelve REs (REs 1 to 12), which are interleaved in each code block (intra-subblock interleaving). In other words, transmission data is composed of seventy-two REs and these seventy-two REs are divided into six code blocks. In addition, among seven symbols (the OFDM symbols of symbol numbers 1 to 7) in one slot, an RS is allocated to one OFDM symbol (the OFDM symbol of symbol number 4) and code blocks 1 to 6 are allocated to the remaining six OFDM symbols in one slot. Moreover, one OFDM symbol contains twelve subcarriers (the subcarriers of subcarrier indexes 1 to 12). Here, a CP of transmission data is not illustrated like Embodiment 1.

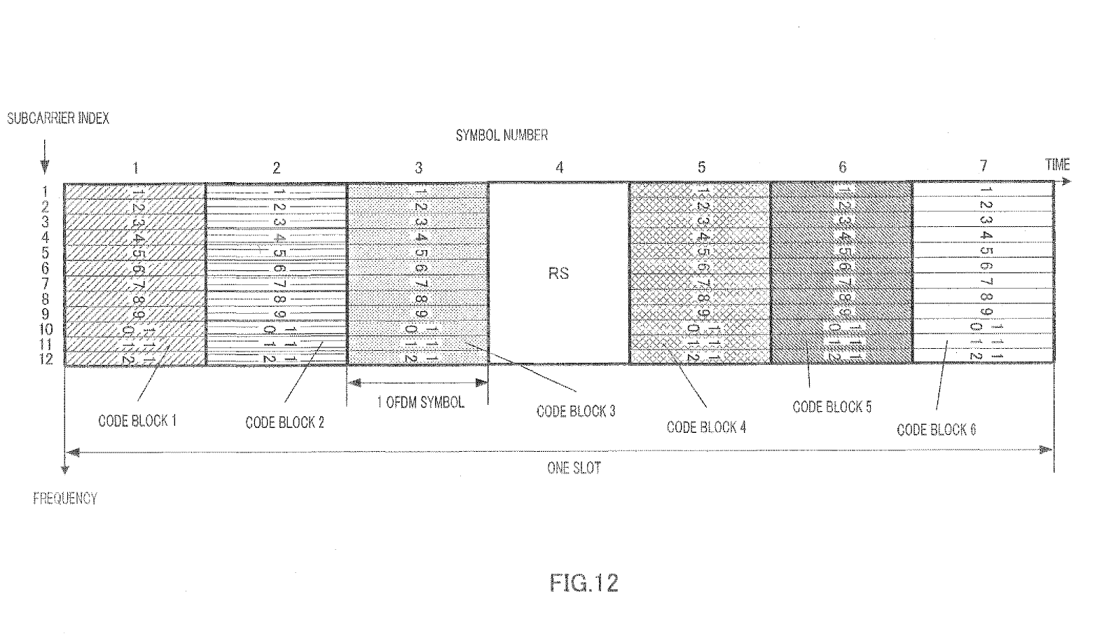

The mobile station according to the present embodiment distributed-allocates seventy-two REs divided into code blocks 1 to 6, on the subcarriers of subcarrier indexes 1 to 12 constituting one OFDM symbol for each of code blocks 1 to 6. That is, a plurality of REs are allocated to one OFDM symbol on a per code block basis. To be more specific, as shown in FIG. 12, REs 1 to 12 in code block 1 are allocated to the subcarriers of subcarrier indexes 1 to 12 in the OFDM symbol of symbol number 1, respectively. Likewise, REs 1 to 12 in code block 2 are allocated to the subcarriers of subcarrier indexes 1 to 12 in the OFDM symbol of symbol number 2, respectively. The same applies to code blocks 3 to 6.

As shown in FIG. 12, code blocks 1 to 6 are distributed-allocated in all the subcarriers of subcarrier indexes 1 to 12. Therefore, OFDMA communication allows the maximum frequency diversity effect.

In addition, as shown in FIG. 12, REs in each code blocks 1 to 6 are collectively allocated to one OFDM symbol on a per code block basis. By this means, a base station can perform sequential processing on a per code block basis without receiving OFDM symbols corresponding to one slot.

Here, comparison will be made between the OFDMA signal according to Embodiment 1 (FIG. 7) and the OFDMA signal according to the present embodiment (FIG. 12). For example, in a case of the OFDMA signal shown in FIG. 7 (Embodiment 1), REs in each code block are distributed-allocated in the OFDM symbols of symbol numbers 1 to 3 and the OFDM symbols of symbol numbers 5 to 7. As a result of this, a base station does not complete reception of all the REs in each code block until receiving the last OFDM symbol of symbol number 7.

By contrast with this, in a case of the OFDMA signal shown in FIG. 12, a base station completes reception of all the REs in one code block every time receiving one OFDM symbol. Therefore, a base station can process code block 1 when receiving the OFDM symbol of symbol number 1 shown in FIG. 12, and process code block 2 when receiving the OFDM symbol of symbol number 2. The same applies to the OFDM symbols of symbol numbers 3 to 6. That is, a base station can sequentially process code blocks every time receiving a symbol. In other words, a base station can perform pipeline processing, and therefore improve the efficiency of data processing.

Here, REs in each code block arranged in the OFDMA signal shown in FIG. 12 are collectively allocated to one OFDM symbol, so that it is not possible to produce time diversity effect. However, when a mobile station does not move fast, a base station can normally receive signals even if time diversity effect is not provided, so that the influence on the system is low.

As described above, according to the present embodiment, a mobile station distributed-allocates a plurality of REs in one OFDM symbol for each of a plurality of code blocks in the frequency domain. By this means, it is possible to preferentially provide frequency diversity effect on each code block. In addition, a mobile station correctively allocates REs for one code block to one OFDM symbol, so that a base station can complete reception of one code block every time receiving one OFDM symbol, and therefore efficiently process code blocks.

Each embodiment according to the present invention has been described.

Here, with the above-described embodiments, eases have been explained as an example where an RS is allocated to the center symbol, among a plurality of symbols constituting one slot. However, the present invention does not limit the location to allocate an RS to the center symbol of one slot.

In addition, with the above-described embodiments, a case has been explained as an example where an RS is allocated to one symbol, among a plurality of symbols constituting one slot. However, according to the present invention, when OFDMA communication is performed, for example, a plurality of OFDM symbols, in which an RS is allocated to part of subcarriers, may be defined.

In addition, with the above-described embodiment, cases have been explained where uplink signals transmitted from a mobile station (that is, uplink signals received by a base station) are transmitted using SC-FDMA or OFDMA. However, according to the present invention, uplink signals transmitted from a mobile station may be transmitted using communication schemes other than SC-FDMA and OFDMA.

Moreover, with the above-described embodiments, cases have been explained where, when OFDMA communication is performed, data symbols sequentially allocated in the time domain are allocated to subcarriers in the frequency domain by S/P conversion processing in the S/P converting section. However, S/P conversion processing is an example of simple processing to allocate data symbols in subcarriers in the frequency domain. Therefore, according to the present invention, when OFDMA communication is performed, processing to allocate data symbols sequentially arranged in the time domain, in the frequency domain is not limited to the S/P processing.

Moreover, a mobile station and base station may be referred to as UE and node B.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-135568, filed on May 23, 2008, including the specification, drawings and abstract, is incorporated herein by reference in its entirety.

### INDUSTRIAL APPLICABILITY

The present invention is applicable to a mobile communication system and so forth.

1. A radio communication mobile station apparatus that performs one of single carrier communication and multicarrier communication, the radio communication mobile station apparatus comprising:
an interleaving section that interleaves a plurality of resource elements divided into a plurality of code blocks in the plurality of code blocks, in a case of whether the single carrier communication is performed or the multicarrier communication is performed; and
an allocation section that distributed-allocates the plurality of resource elements after interleaving for each of the plurality of code blocks in a frequency domain, only when the multicarrier communication is performed.

2. The radio communication mobile station apparatus according to claim 1, wherein the allocation section evenly allocates the plurality of resource elements after interleaving for each of the plurality of code blocks in the frequency domain.

3. The radio communication mobile station apparatus according to claim 1, wherein the allocation section shifts the plurality of resource elements after interleaving on a per symbol basis, using a different shift value on a per symbol basis in the frequency domain.

4. The radio communication mobile station apparatus according to claim 3, wherein the allocation section applies a shift value ((n−1)×Nsub/Nsyrn) to a symbol of symbol number n (here, Nsub is a number of subcarriers used in the multicarrier communication and Nsym is a number of symbols per slot.)

5. The radio communication mobile station apparatus according to claim 1, wherein the allocation section allocates the plurality of resource elements after interleaving such that each of the plurality of code blocks holds a mirror-image relationship, with respect to a center location in a plurality of symbols composed of the plurality of resource elements in a time domain.

6. The radio communication mobile station apparatus according to claim 1, wherein the allocation section randomly allocates the plurality of resource elements after interleaving for each of the plurality of code blocks in the frequency domain.

7. A resource element distributed allocation method in a radio communication mobile station apparatus that performs one of single carrier communication and multicarrier communication, the resource element allocation method comprising:
only when the multicarrier communication is performed, distributed allocating a plurality of resource elements for each of a plurality of code block in a frequency domain, the plurality of resource elements are interleaved in the plurality of code blocks composed of the plurality of resource elements in a case of whether the single carrier communication is performed or the multicarrier communication is performed.
